(19) United States
(12) Patent Application Publication
(10) Pub. No.: US 2023/0282012 A1
(43) Pub. Date: Sep. 7, 2023

(54) GENERATING TRAINING DATA FOR MACHINE LEARNING

(71) Applicant: Robert Bosch GmbH, Stuttgart (DE)

(72) Inventor: Julio Borges, Stuttgart (DE)

(21) Appl. No.: 18/176,644

(22) Filed: Mar. 1, 2023

(30) Foreign Application Priority Data
Mar. 4, 2022 (DE) 10 2022 202 223.8

(51) Int. Cl. G06V 20/70; G06V 10/46; G06V 10/82; G06T 7/194

(52) U.S. Cl. CPC G06V 20/70; G06V 10/462; G06V 10/82; G06T 7/194

(57) ABSTRACT

A computer-implemented method for generating training data for machine learning and a machine learning method, in particular a self-monitored learning method. The learning method using training data which are generated according to a method for training a neural network.

### CROSS REFERENCE

The present application claims the benefit under 35 U.S.C. § 119 of German Patent Application No. DE 10 2022 202 223.8 filed on Mar. 4, 2022, which is expressly incorporated herein by reference in its entirety.

### BACKGROUND INFORMATION

Neural networks, in particular deep neural networks (DNNs) are widely used in the area of computer vision, for example in the area of image recognition.

One disadvantage of DNNs is a lack of domain-overlapping generalization. It is not possible to guarantee that trained DNNs will function well in a changed situation and/or a new, unknown domain. One reason for this problem is known as so-called shortcut learning. Shortcut learning occurs when a model adapts a problem to data of which it is not to be expected that they are relevant or present. This may be illustrated on the basis of an example. For example, a DNN may reliably recognize cows in front of a grass landscape, since cows stand randomly on a meadow in typical training images. However, the same DNN may fail if it is tested using cow images outside the grass landscape, for example on a road. This shows that grass is an unintended (shortcut) indication of cows.

This problem may also occur in self-monitored learning methods. Intelligent, self-learning systems are designed to use machine learning algorithms in order to carry out in an automated manner classification, prediction, or pattern recognition methods to be learned in a training. Such systems are usable for diverse tasks.

Contrastive learning methods learn a representation space, including feature and embedding, from the input image space, in that they carry out a contrastive instance differentiation: proceeding from a detail x^{q} of a starting image, which relates to a foreground object, another random detail of the same image is labeled as a positive detail x⁺ and details from other randomly selected images are labeled as negative details x⁻. The pair (x^{q}, x⁺) is referred to as a positive pair, alternatively also (x⁺, x⁺). The features of detail x^{q} of the starting image and associated positive detail x⁺ are brought together, while those from negative details x⁻ are pushed aside.

However, the learning of shortcuts may also occur here if an image detail of a foreground object is incorrectly linked in the learned representation space with a detail of the background.

The present invention addresses this problem.

### SUMMARY

One specific example embodiment of the present invention relates to a computer-implemented method for generating training data for machine learning, in particular self-monitored learning, the method. The method includes the following steps:
providing input image data including at least two input images different from one another;
generating counterfactual image data including at least one counterfactual image based on the input image data;
generating labeled image details by labeling at least one image detail of a counterfactual image and at least one further image detail of another image different therefrom, in particular at least one counterfactual image or an input image, and providing the labeled image details as training data for machine learning.

It is thus provided that to generate training data, an image generation process be controlled in such a way that the generation of counterfactual images is enabled. Counterfactual images are atypically composed images. Such counterfactual images may be generated by compiling image components from real images, but also image components from synthetic images and/or synthetic image components. Synthetic image components or synthetic images may be generated by computer programs, in particular GANs, generative adversarial networks.

The labeling of image details proceeds from an image detail of a counterfactual image, which relates to a foreground object.

Proceeding therefrom, another image detail of another image different therefrom but correlated in content, in particular another counterfactual image or an input image, is labeled as a positive detail.

Another image detail of another image different therefrom and not correlated in content, in particular another counterfactual image or an input image, is labeled as a negative image detail.

Images correlated in content are understood to mean that at least the shape of a particular foreground object which is represented in the particular images relates to the same object.

Images not correlated in content are understood to mean that at least the shape of a particular foreground object which is represented in the particular images does not relate to the same object. Not correlated in content is in general understood as those images which are not to be connected to one another during the learning, thus the details of which are labeled as negative details x⁻ in the context of contrastive learning.

If these image details labeled in this way are used as training data, a robust representation space may thus be learned for various classification tasks of images, images having identical content with respect to the foreground object and variations in noncausal components, for example of the background, spatially close to one another, are learned.

According to one specific example embodiment of the present invention, it is provided that the generation of counterfactual image data includes: extracting at least one image component from a particular input image of the input image data. A counterfactual image then in turn includes unseen combinations of the image components.

According to one specific example embodiment of the present invention, it is provided that an image component includes at least one of the following elements and/or is associated with one of the following elements: an object shape of an object represented in an input image, a texture of an object represented in an input image, and/or a background of an input image. Each input image may thus be decomposed into three independent components, namely object shape, texture, and background, in that these components are separated from one another.

According to one specific example embodiment of the present invention, it is provided that the extraction of a first image component, in particular an object shape, from an input image is carried out using at least one binary mask, in particular including a salience detector, for segmenting a foreground represented in the image, which is associated with the object represented in the input image. The input image data may include already labeled masks, for example manually labeled masks. However, the manual labeling of such masks is generally time-consuming and therefore linked to high costs. It may therefore prove to be advantageous to use a salience detector.

For example, a binary edge mask and a binary shape mask are used.

According to one specific example embodiment of the present invention, it is provided that the extraction of another image component, in particular a texture, from an input image includes merging areas of a segmented foreground, which are associated with an object of the input image, to form a texture map. Alternatively, a synthetic texture or a texture of the foreground object itself may also be used.

According to one specific example embodiment of the present invention, it is provided that the extraction of another image component, in particular a background, from input image data includes: extracting a segmented foreground, which is associated with an object of the input image, and filling up the extraction area using adjacent areas. Alternatively, a synthetic background may also be used.

According to one specific example embodiment of the present invention, it is provided that the generation of the counterfactual image data furthermore includes: merging image components, at least two of the elements originating from input image data different from one another, to form a counterfactual image.

According to one specific example embodiment of the present invention, it is provided that at least one first image component, which includes an object shape and/or is associated therewith, and another image component, which includes a texture and/or is associated therewith, and/or another image component, which includes a background and/or is associated therewith, are merged. The image components may originate from real images. Alternatively, the image components may also originate from synthetic images and/or may be synthetic image components. The merging also includes generating synthetic images.

A counterfactual image includes, for example, an object shape from an input image, at least the background or the texture advantageously originating from another input image. In particular, the background and/or texture may also include synthetic image components and/or image components from synthetic images. The counterfactual image may also be entirely or partially synthetically generated, for example with the aid of GANs, generative adversarial networks.

Advantageously, according to an example embodiment of the present invention, at least the background or the background and the texture are varied.

The merging of the image components to form counterfactual image data is described by:

X^{k}=T⊙Mₛ⊙Mₑ+B⊙(1−Mₛ).

Other specific embodiments of the present relate to a device, in particular a computer, for generating training data for machine learning, the device including at least one processor, at least one memory, and at least one interface. The device is designed to carry out the method according to the described specific embodiments of the present invention.

Other specific embodiments of the present invention relate to a computer program, the computer program including computer-readable instructions, upon whose execution by a computer, at least one step runs in a method according to the described specific embodiments of the present invention.

Other specific embodiments of the present invention relate to a machine learning method, in particular a self-monitored learning method, the learning method using training data which were generated according to a method according to the described specific embodiments of the present invention.

According to one specific example embodiment, it is provided that the training data include labeled image details, the labeled image details including at least one image detail of a counterfactual image and at least one further image detail of a further image different therefrom, in particular a further counterfactual image or an input image.

Other specific embodiments of the present invention relate to a device for carrying out a machine learning method according to the described specific embodiments.

Further features, possible applications, and advantages of the present invention result from the following description of exemplary embodiments of the present invention, which are represented in the figures. All described or represented features form the subject matter of the present invention as such or in any combination, regardless of their formulation or representation in the description herein or in the figures.

### BRIEF DESCRIPTION OF THE DRAWINGS

FIG. 1 shows a schematic representation of steps of a method for generating training data, according to an example embodiment of the present invention.

FIG. 2 shows a schematic representation of steps of the method for generating training data, according to an example embodiment of the present invention.

FIG. 3 shows a schematic representation of a device for generating training data, according to an example embodiment of the present invention.

FIG. 4 shows a schematic representation of an architecture for generating training data and for machine learning, according to an example embodiment of the present invention.

### DETAILED DESCRIPTION OF EXAMPLE EMBODIMENTS

It is presumed that an image composition of an image X is described by three independent mechanisms and a deterministic function f_{SY N}, which relates to the compilation of these mechanisms.

A first mechanism relates to an object shape M of an object O represented in the image and is formally described by:

M:=fₛₕₐₚₑ(Y₁,U₁)

A second mechanism relates to a texture T of object O represented in the image and is formally described by:

T:=fₜₑₓₜᵤᵣₑ(Y₂,U₂)

A third mechanism relates to a background B and is formally described by:

B:=f_{background}(Y₃,U₃)

An image X is formally described by

X:=f_{SY N}(M,T,B)

Inputs Yᵢ of the three mechanisms represent the “class labels” for object shape M, texture T, and background B. Uᵢ describes external factors or exogenous noises and provides random variations of M, T, B at Yᵢ.

In conventional training data sets, there was generally a strong correlation between various class labels, for example Y₁, Y₂, and Y₃. For example, for an image which represents a cow, the form of the cow mostly correlates with white-brown hair as texture and grass as the background. A given object O at the example of a cow, results in most training images in the following class labels: Y₁=cow shape, Y₂=cow texture, and usually Y₃=grass background or occasionally Y₃=barn background. These class labels are correlated during the learning, this correlation between Y₃ and Y₁, Y₂ then being the reason for the learning of shortcuts.

In the context of the present invention, it is provided that the correlation between background B and object shape M and/or background B and texture T remains unconsidered. Therefore, only object shape and texture and not the background are to be used as features for an object classification. The learning of shortcuts is therefore to be avoided and it is thus to be ensured that in the application of a trained model, objects may also be reliably recognized in image data having a background not present in the training data. For example, a cow on a road is also to be reliably recognized when the training data set does not contain any images of cows on a road.

An image generation process and the control thereof is described hereinafter, which enables the generation of counterfactual images by composition.

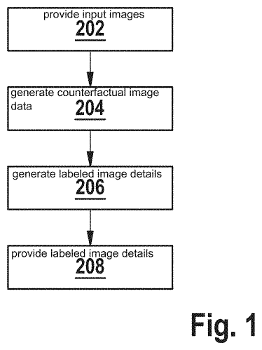

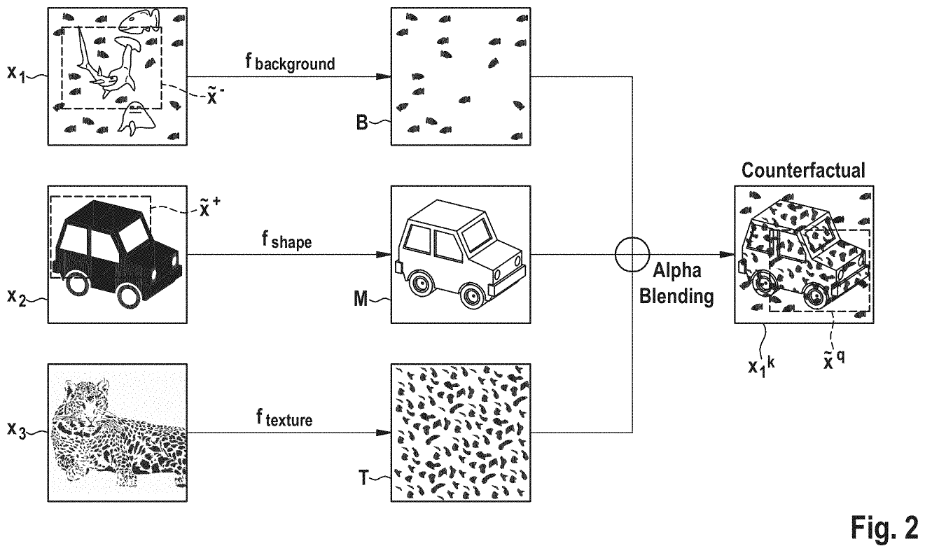

A method for generating training data based on the above-described fundamentals is explained hereinafter on the basis of FIGS. 1 and 2.

A step 202 includes providing input image data X including at least two input images different from one another.

Exemplary input images x₁, x₂, and x₃ are shown in FIG. 2.

A step 204 includes generating counterfactual image data X^{k} including at least one counterfactual image based on input image data X.

An exemplary counterfactual image x₁^{k} is shown in FIG. 2.

Generating counterfactual image data X^{k} on the basis of counterfactual image x₁^{k} is described hereinafter.

Generating 204 counterfactual image data X^{k} includes: extracting at least one image component from a particular input image x₁, x₂, x₃ of input image data X.

An image component includes at least one of the following elements and/or is associated with one of the following elements: an object shape M of an object O represented in an input image, a texture T of an object O represented in an input image, and/or a background B of an input image.

The extraction of a first image component, in the example object shape M, will be explained on the basis of the example of input image x₂. An object, in the example a vehicle, is represented in input image x₂ in the foreground.

The extraction of object shape M is carried out using at least one binary mask, in particular including a salience detector, for segmenting the foreground represented in the image, which is associated with the object represented in the input image. Shape M of object O represented in the image is thus modeled.

The input image data may include already labeled masks, for example manually labeled masks. In general, manually labeling such masks is time-consuming and therefore linked to high costs, however. It may therefore prove to be advantageous to use a salience detector. The use of a salience detector is explained hereinafter on the basis of example. A binary mask in the example includes a shape mask Mₛ and an edge mask Mₑ.

The extraction of a shape mask Mₛ from the data of image data X is preferably carried out using a pre-trained U² network, which was trained for category-independent segmentation of object salience. That means the U² network is capable of recognizing an object in the foreground of an image, regardless of a category of the object, and thus different objects. Such a network is described, for example, in Qin, X.; Zhang, Z. V.; Huang, C.; Dehghan, M.; Zaiane, O. R.; and Jagersand, M. 2020; “U²-net: Going deeper with nested u-structure for salient object detection,” Pattern Recognit. 106:107404.

The use of salience detectors results in strong distortion, in particular an overestimation in the extraction of shapes, which are clearly delimited from the background. This may either have the result that areas of the background are recognized as the object and segmented or that an object, or parts thereof, is not recognized as an object and is therefore not segmented.

To minimize these errors in the modeling of the shape of an object, it is provided that a shape mask Mₛ is used, which meets the following condition:

$$ζ := \frac{1}{K} {\sum }_{i = 1}^{K} {{m}_{s}^{[ 1 ]} > {λ}_{s}}_{}$$

$$β \leq ζ \leq 1 - β$$

mₛ^{[1]} being the output of the salience detector, thus a mask between 0, background, and 1, foreground, for the ith pixel in an image having K pixels, β being the minimum ratio of the masks to the image, and λₛ being a scalar threshold value for mₛ^{[1]} in the foreground. The ratio of the mask to the image is selected, for example, as β=0.1. This means the mask is to contain at least 10% and at most 90% of the image, otherwise the image is ignored for the mask extraction. For the conversion of the salience probabilities into a binary shape mask Mₛ, in the example a threshold value λₛ=0.5 is used. Another ratio between mask and image and/or another threshold value may also be selected.

The extraction of an edge mask Mₑ from image data is carried out, for example, with the aid of a model for convolutional edge recognition, for example Liu, Y.; Cheng, M.-M.; Hu, X.; Wang, K.; and Bai, X. 2017; “Richer convolutional features for edge detection;” in Proceedings of the IEEE conference on computer vision and pattern recognition, 3000-3009. Pieces of edge information may thus be taken into consideration in addition in the modeling of the shape of an object. For the conversion of the edge probabilities into a binary edge mask Mₑ, in the example a threshold value λₛ=0.6 is used. This threshold value has proven to be advantageous and leads to better results. However, another threshold value may also be selected.

Extracting a further image component, in the example texture T of an object, from an input image is explained on the basis of the example of input image x₃. In input image x₃, an object, in the example a leopard, is shown in the foreground. Extracting texture T includes merging areas of the segmented foreground, which are associated with the object of the input image, to form a texture map.

The foreground segmentation extracted from the U² network may again be used for modeling texture T. In this way, the area of input image x₃ which shows the leopard may be identified. To extract texture T, the areas of the segmented foreground, in which the object is located, are then assembled like individual patches to form a texture map, for example with the aid of image quilting, for example Efros, A. A., and Freeman, W. T. 2001; “Image quilting for texture synthesis and transfer;” in Proceedings of the 28th annual conference on Computer graphics and interactive techniques, 341-346.

Alternatively, the texture may also be synthetically generated and/or extracted from synthetic images.

Extracting a further image component, in the example background B, from an input image will be explained on the basis of the example of input image x₁. In input image x₁, an object, in the example a shark, is shown in the foreground.

Extracting background B includes extracting the segmented foreground, which is associated with the object of the input image, and filling up the extraction area using adjacent areas of the background. In principle, the extraction of the foreground may also be based on labeled masks. Alternatively, the salience-based foreground segmentation extracted from the U² network may again be used for identifying the object in the foreground. In this way, the area of input image x₁ which shows the shark may be identified. The object is extracted and the extraction area is assembled with areas of the background like individual patches. The extraction area is understood as the area in which the object is located before the extraction. The extraction area is advantageously assembled from areas of the background adjacent thereto, thus areas of the background which adjoin the extraction area. Deep learning-based inpainting techniques are to be avoided for replacing the removed foreground. Such methods may result in distortions, which the inpainting model has learned from the data.

Alternatively, the background may also be synthetically generated and/or extracted from synthetic images.

Generating 204 counterfactual image data X^{k} again includes the merging of the elements: object shape M, texture T, and background B, at least two of the elements originating from input image data different from one another, to form a counterfactual image, in the example image x₁^{k}.

In the example shown in FIG. 2, background B from image x₁, the shape of the object from image x₂, and texture T from image x₃ are merged to form counterfactual image x₁^{k}.

Merging masks Mₑ, Mₛ, which describe a shape of the object of the image, texture T of the object, and background B to form counterfactual image data X^{k} may be described as follows:

X^{k}=T⊙Mₛ⊙Mₑ+B⊙(1−Mₛ),

“⊙” designating element-wise multiplication.

Proceeding from extracted M, T, and B, counterfactual image data may be compiled, in particular randomly, on the basis of a random generation of these elements. In this way, numerous permutations may be generated based on the input image data.

Method 200 furthermore includes a step 206 for generating labeled image details by labeling at least one image detail of a counterfactual image and at least one other image detail of another image different therefrom, in particular another counterfactual image or an input image.

The method proceeds from an image detail \tilde{x}^{q} of a counterfactual image, which relates to a foreground object. Proceeding therefrom, another image detail of another image different therefrom but correlated in content, in particular another counterfactual image or an input image, is labeled as a positive detail \tilde{x}⁺.

Another image detail of another image different therefrom and not correlated in content, in particular another counterfactual image or an input image, is labeled as a negative image detail \tilde{x}⁻.

Images correlated in content are understood to mean that at least the shape of a particular foreground object which is shown in the particular images relates to the same object. For example, both the shape of the foreground object of input image x₂ and the shape of the foreground object of counterfactual image x₁^{k} correspond to the shape of a vehicle. These images are therefore viewed as correlated in content.

Images not correlated in content are understood to mean that at least the shape of a particular foreground object which is shown in the particular images does not relate to the same object. For example, the shape of the foreground object of input image x₂ corresponds to a vehicle and the shape of the foreground object of input image x₁ corresponds to a shark. These images are therefore viewed as not correlated in content.

In the example, image detail \tilde{x}^{q} of counterfactual image x₁^{k} and image detail \tilde{x}⁺ from input image x₂ are labeled as a positive pair (\tilde{x}^{q}, \tilde{x}⁺).

In the example, the positive pair includes image detail \tilde{x}^{q} from image x₁^{k} and image detail \tilde{x}⁺ from image x₂.

In the example, image detail \tilde{x}^{q} of counterfactual image x₁^{k} and image detail \tilde{x}⁻ from input image x₁ are labeled as a negative pair (\tilde{x}^{q}, \tilde{x}⁻).

In the example, the negative pair includes image detail \tilde{x}^{q} from image x₁^{k} and image detail \tilde{x}⁻ from image x₁.

In method 200, it may advantageously be provided that shape and texture are retained in at least one image detail of a positive pair, and thus correspond to the original. The background may be varied in both image details of a positive pair.

Method 200 furthermore includes a step 208 for providing the labeled image details as training data for machine learning.

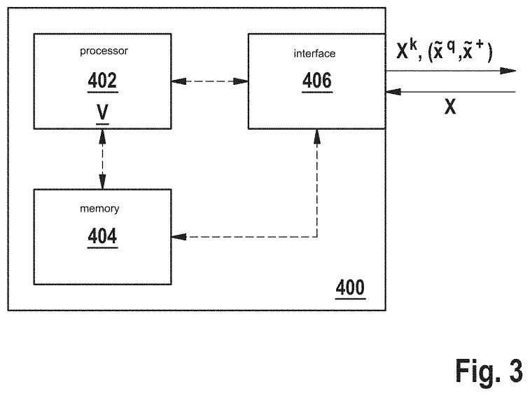

FIG. 3 schematically shows a device 400, which is designed to carry out method 200.

Device 400 is, for example, a computer. The device may also be a control unit. Device 400 includes a processor 402, at least one memory 404, and at least one interface 406.

Input image data X are provided via interface 406. Training data, in particular including counterfactual image data X^{k} and/or labeled image details \tilde{x}^{q}, \tilde{x}⁺, \tilde{x}⁻ are provided via interface 406 or via a further interface.

The steps described in reference to method 200 for generating training data based on the extraction of image components and the renewed compilation of individual image components to form counterfactual image data X^{k} may also be referred to as content-modifying changes.

In addition, it may advantageously be provided that further style-modifying changes are carried out on input image data X and/or on counterfactual image data X^{k} and/or on labeled image details \tilde{x}^{q}, \tilde{x}⁺, \tilde{x}⁻.

Style-modifying changes include, for example, cropping, in particular random mirroring, for example horizontal mirroring, color change, for example color jittering, color variations, B/W colorations, grayscale colorations, soft focus, for example Gaussian blur, and changes of the exposure, for example overexposure.

Style-modifying changes may advantageously be applied randomly. A probability, in particular with respect to each individual style-modifying change, at which the changes are applied, may advantageously be predetermined.

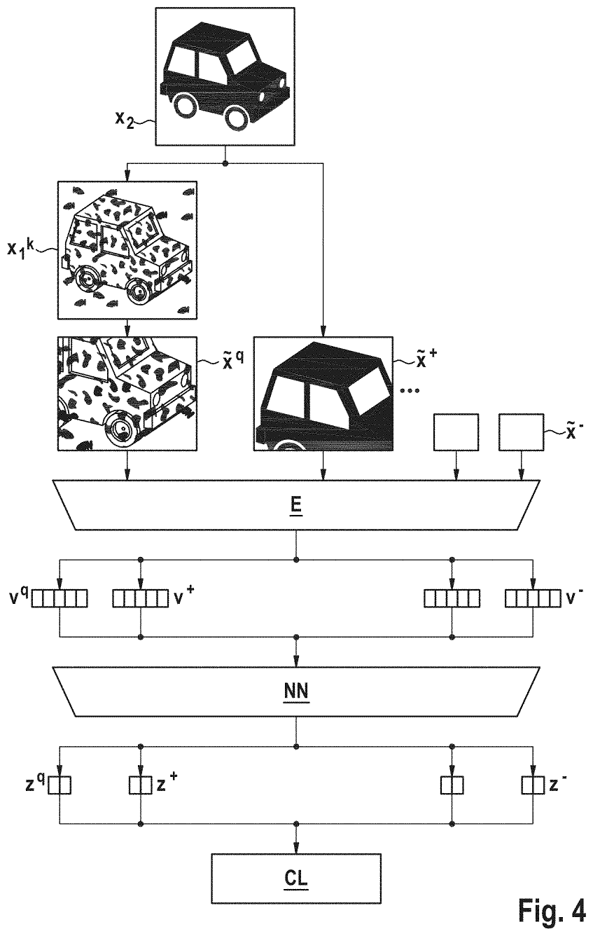

FIG. 4 shows a schematic representation of an architecture for generating training data and a machine learning method, in particular a self-monitored learning method.

The upper part corresponds to the steps already described of method 200. Proceeding from input image x₂, counterfactual image x₁^{k} is generated. Image details are then labeled as positive \tilde{x}⁺ or negative \tilde{x}⁻ proceeding from an image detail \tilde{x}^{q}.

Image detail \tilde{x}^{q}, image detail \tilde{x}^{q} of counterfactual image x₁^{k} here, and another image detail \tilde{x}⁺, of an image different therefrom and correlated in content, image detail \tilde{x}⁺ of input image x₂ here, form a positive pair.

Image detail \tilde{x}^{q} and another image detail \tilde{x}⁻, of an image different therefrom and not correlated in content, image detail \tilde{x}⁻ of input image x₁ here, form a negative pair.

In addition, it may be provided that further style-modifying changes are carried out on input image data X and/or on counterfactual image data X^{k} and/or on image details \tilde{x}^{q}, \tilde{x}⁺, \tilde{x}⁻.

An encoder E and a neural network NN, for example a multilayer perceptron with one hidden neuron layer, also referred to as a projection head, are trained to maximize the correspondence in content using a contrastive loss CL.

Encoder E generates, based on labeled image details \tilde{x}^{q}, \tilde{x}⁺, \tilde{x}⁻ representation vectors v^{q}, v⁺, v⁻, which represent labeled image details \tilde{x}^{q}, \tilde{x}⁺, \tilde{x}⁻ in the vector space.

Proceeding therefrom, the neural network learns an embedding space in which embeddings z^{q}, z⁺ of representation vectors v^{q}, v⁺ of image details \tilde{x}^{q}, \tilde{x}⁺ which form a positive pair (\tilde{x}^{q}, \tilde{x}⁺) are close to one another, while embeddings z^{q}, z⁻ of representation vectors v^{q}, v⁻ of image details \tilde{x}^{q}, \tilde{x}⁻, which form a negative pair (\tilde{x}^{q}, \tilde{x}⁻) are dissimilarly far away from one another.

Embeddings, also embedding vectors, z^{q}, z⁺, z⁺⁻ are normalized in the example to a unit sphere, to prevent the space from collapsing or expanding.

The NN solves the classification problem, in which deviations between the query (z^{q}) and other examples (z⁺, z⁻) are scaled with a temperature parameter τ=0.07 and transferred as logits.

The cross-entropy loss is computed, which represents the probability that the positive example is selected over the negative examples:

$$l ( {z}^{q} , {z}^{+} , {z}^{-} ) = - log [ \frac{exp ( {z}^{q} \cdot {z}^{+} / τ )}{exp ( {z}^{q} \cdot \frac{{z}^{+}}{τ} ) + {\sum }_{n = 1}^{2 ( N - 1 )} exp ( {z}^{q} \cdot \frac{{z}^{-}}{τ} )} ]$$

where “·” represents the scalar product.

By using the image details labeled according to method 200 as training data, a robust representation space may be learned for various classification tasks of images, images being learned having identical content with respect to the foreground object and variations in noncausal components, for example of the background, spatially close to one another. The learned representation is concentrated on the object content and is invariant with respect to pieces of background information.

The background invariance may be achieved in that background counterfactuals are used. This means that shape and texture are retained in at least one image detail of a positive pair, the background being randomized.

What is claimed is:

1. A computer-implemented method for generating training data for machine learning, including self-monitored learning, the method comprising the following steps:
providing input image data including at least two input images different from one another;
generating counterfactual image data including at least one counterfactual image based on the input image data;
generating labeled image details by labeling at least one image detail of a counterfactual image of the at least one counterfacture image and at least one further image detail of another image different therefrom including another counterfactual image of the at least one counterfacture image or an input image of the at least two images; and
providing the labeled image details as training data for the machine learning.

2. The method as recited in claim 1, wherein the generating of the counterfactual image data includes: extracting at least one image component from a particular input image of the input image data.

3. The method as recited in claim 2, wherein each of the at least one image component includes at least one of the following elements and/or is associated with one of the following elements: an object shape of an object represented in an input image of the at least two input images and/or a texture of an object represented in an input image of the at least two input images, and/or a background of an input image of the at least two input images.

4. The method as recited in claim 2, wherein the extracting of the at least one image component from the input image includes extracting an object shape of an object in the input image, the extracting being carried out using at least one binary mask having a salience detector, for segmenting a foreground represented in the input image, which is associated with the object represented in the input image.

5. The method as recited in claim 4, wherein the at least one binary mask includes a binary edge mask and a binary shape mask.

6. The method as recited in claim 2, wherein the extracting of the at least one image component from an input image of the at least two input images includes merging areas of a segmented foreground which are associated with an object of the input image to form a texture map, the at least one image component including a texture.

7. The method as recited in claim 2, wherein the extracting of the at least one image component from an input image of the at least two input images includes extracting a segmented foreground, which is associated with an object of the input image, and filling up the extraction area using adjacent areas, the at least one image component including a background.

8. The method as recited in claim 2, wherein the generating of the counterfactual image data includes: merging image components, at least two of the image components originating from input image data different from one another, to form the counterfactual image.

9. The method as recited in claim 8, wherein at least one first image component, which includes an object shape and/or is associated the object shape, and another image component, which includes a texture and/or is associated with the texture, and another image component, which includes a background and/or is associated with the background, are merged.

10. The method as recited in claim 9, wherein the merging of the image components to form counterfactual image data (X^{k}) is described by:
X^{k}=T⊙Mₛ⊙Mₑ+B⊙(1−Mₛ)
wherein T is the texture, Mₛ is a binary shape mask, Mₑ is a binary edge mask, and B is the background.

11. A device for generating training data for machine learning, comprising:
at least one processor;
at least one memory; and
at least one interface;
wherein the device is configured to:
provide input image data including at least two input images different from one another;
generate counterfactual image data including at least one counterfactual image based on the input image data;
generate labeled image details by labeling at least one image detail of a counterfactual image of the at least one counterfacture image and at least one further image detail of another image different therefrom including another counterfactual image of the at least one counterfacture image or an input image of the at least two images; and
provide the labeled image details as training data for the machine learning.

12. A non-transitory computer-readable medium on which is stored a computer program including computer-readable instructions for generating training data for machine learning, including self-monitored learning, the instruction, when executed by a computer, causes the computer to perform the following steps:
providing input image data including at least two input images different from one another;
generating counterfactual image data including at least one counterfactual image based on the input image data;
generating labeled image details by labeling at least one image detail of a counterfactual image of the at least one counterfacture image and at least one further image detail of another image different therefrom including another counterfactual image of the at least one counterfacture image or an input image of the at least two images; and
providing the labeled image details as training data for the machine learning.

13. A self-monitored learning method, the method comprising:
training a neural network using training data, the training data being generated by:
providing input image data including at least two input images different from one another,
generating counterfactual image data including at least one counterfactual image based on the input image data,
generating labeled image details by labeling at least one image detail of a counterfactual image of the at least one counterfacture image and at least one further image detail of another image different therefrom including another counterfactual image of the at least one counterfacture image or an input image of the at least two images, and
providing the labeled image details as the training data for the machine learning.

14. A device configured to train a neural network, the device being configured to:
train the neural network using training data, the training data being generated by:
providing input image data including at least two input images different from one another,
generating counterfactual image data including at least one counterfactual image based on the input image data,
generating labeled image details by labeling at least one image detail of a counterfactual image of the at least one counterfacture image and at least one further image detail of another image different therefrom including another counterfactual image of the at least one counterfacture image or an input image of the at least two images, and
providing the labeled image details as the training data for the machine learning.
